(19) United States
(12) Patent Application Publication
(10) Pub. No.: US 2024/0149258 A1
(43) Pub. Date: May 9, 2024

(54) PHOTOCATALYSTS AND METHODS OF MAKING AND USING THE SAME

(71) Applicant: Trustees of Tufts College, Medford, MA (US)

(72) Inventors: Mary Jane Shultz, Natick, MA (US); Nicholas J. Anderson, Boston, MA (US); Tongzhou Xu, Beijing (CN); Patrick Bisson, Lowell, MA (US)

(21) Appl. No.: 18/255,535

(22) PCT Filed: Dec. 2, 2021
(86) PCT No.: PCT/US21/72716

§ 371 Date: Jun. 1, 2023

Related U.S. Application Data
(60) Provisional application No. 63/120,628, filed on Dec. 2, 2020.

(51) Int. Cl. B01J 35/00; B01J 21/06; B01J 23/26; B01J 23/30; B01J 23/34; B01J 23/36; B01J 23/652; B01J 23/656; B01J 23/68; B01J 23/72; B01J 23/755; B01J 23/80; B01J 23/86; B01J 23/888; B01J 23/889; B01J 23/89; B01J 37/02; B01J 37/34

(52) U.S. Cl. CPC B01J 35/004; B01J 21/063; B01J 23/26; B01J 23/30; B01J 23/34; B01J 23/36; B01J 23/6522; B01J 23/6527; B01J 23/6562; B01J 23/685; B01J 23/687; B01J 23/688; B01J 23/72; B01J 23/755; B01J 23/80; B01J 23/866; B01J 23/868; B01J 23/888; B01J 23/8892; B01J 23/8896; B01J 23/8906; B01J 35/0013; B01J 37/0215; B01J 37/345

(57) ABSTRACT

Photocatalysts and methods of making and using the same are disclosed. The photocatalyst includes a TIO2 ultra-nanoparticle having a single Fe, Co, Mn, Cr, or W atom positioned as an engineered defect within the particle and a single metal catalyst atom bound proximal to the single Fe, Co, Mn, Cr, or W atom. The method of making the photocatalyst includes generating a plurality of ultra-nano TIO2 particles, each having a single Fe, Co, Mn, Cr, or W atom positioned as an engineered defect within the particle. The method further includes photodepositing a single metal catalyst atom proximal to the single Fe, Co, Mn, Cr, or W atom for at least a portion of the ultra-nano TIO2 particles, thereby creating the disclosed photocatalyst. The single metal catalyst atom is in a positive oxidation state and can be Pt, Pd, Ir, Ru, Rh, Os, Re, Au, Ni, Zn, or Cu.

### CROSS-REFERENCE TO RELATED APPLICATIONS

This application is related to, claims priority to, and incorporates by reference herein for all purposes U.S. Provisional Patent Application No. 63/120,628, filed Dec. 2, 2020.

### STATEMENT REGARDING FEDERALLY FUNDED RESEARCH

This invention was made with government support under grant DE-SC0020258 awarded by the Department of Energy. The government has certain rights in the invention.

### BACKGROUND

A growing body of work suggests that, for many catalytic processes, single noble-metal atoms are not only more stable but also more active and chemically selective than small nanoclusters or nanoparticles. Strategies for depositing single atom (“SA”) catalysts on a substrate often leverage substrate defects to stabilize the single atoms. By their nature, defect sites are typically uncontrolled and nonuniform, resulting in a mixture of single-atoms and atomic clusters, stably bound and labile atoms. The resulting mixture of single, stable sites and sites or clusters that lead to agglomeration results in degradation of catalyst structure and activity.

A need exists for new platforms and technologies for providing single atom catalysts in a usable, stable form and having the potential for scaling up for industrial applications.

### SUMMARY

In an aspect, the present disclosure provides a photocatalyst. The photocatalyst includes a TiO₂ ultra-nanoparticle having a single Fe, Co, Mn, Cr, or W atom positioned as an engineered defect within the particle and a single metal catalyst atom bound proximal to the single Fe, Co, Mn, Cr, or W atom. The single metal catalyst atom is in a positive oxidation state.

In another aspect, the present disclosure provides a method of making a photocatalyst. The method includes: a) generating a plurality of ultra-nano TiO₂ particles, each having a single Fe, Co, Mn, Cr, or W atom positioned as an engineered defect within the particle; and b) photodepositing a single metal catalyst atom proximal to the single Fe, Co, Mn, Cr, or W atom for at least a portion of the plurality of ultra-nano TiO₂ particles, thereby resulting in a portion of the plurality of ultra-nano TiO₂ particles having a single Fe, Co, Mn, Cr, or W atom positioned as an engineered defect within the particle and the single metal catalyst atom bound proximal to the single Fe, Co, Mn, Cr, or W atom.

### BRIEF DESCRIPTION OF THE DRAWINGS

FIG. 1 is an ideal truncated square bipyramid structure of anatase, TiO₂ containing approximately 100 formula units. The structure is primarily delineated by the large-area, stable faces and is capped by the small-area, high-energy [001] faces.

FIG. 2A includes data relating to oxidation of formaldehyde by Pt—Fe TUNP. For enhancing photo activity, the Fe doping and Pt capture are connected. For 1.5 wt % Pt solution concentration, the highest Fe doping level for SA Pt photocapture is 1%, corresponding to 1 Fe atom per particle.

FIG. 2B includes data relating to oxidation of formaldehyde by Pt—Fe TUNP. For enhancing photo activity, the Fe doping and Pt capture are connected. At a fixed 1 Fe atom per particle, the best SA Pt capture corresponds to 0.17 Pt atoms/particle. Larger Pt concentrations result in Pt NPs and degraded activity.

FIG. 2C includes data relating to oxidation of formaldehyde by Pt—Fe TUNP. For enhancing photo activity, the Fe doping and Pt capture are connected. The interplay between Fe doping and Pt loading shows that the highest efficiency is attained by particles that have a distribution of 1 Fe atom and 0.17 Pt atoms per particle: 17% of nanoparticles are highly active Pt₁-Fe₁·TiUNP.

FIG. 3 is a plot of CO-DRIFTS of Pt decorated Fe·TiUNP after formaldehyde oxidation: (bottom) 4-hr. photodeposition, (top) extended photodeposition times. (Curves vertically offset for clarity.) The peak at 2104 cm⁻¹ indicates a linear CO—Pt stretch: a single atom Pt site. Absence of a broad 1800-1950 cm⁻¹ band corresponding to bridge-bonded CO—Pt stretches confirms atomically dispersed Pt (top). Extended photodeposition times generate metallic Pt clusters, as shown by the broad peak at approximately 1800 cm⁻¹. Mass balance indicates that after 4 hours, 17% of the particles have a single Pt atom decoration.

FIG. 4 is an x-ray absorption near edge spectroscopy (XANES) discussed in Example 1. XANES indicates that Pt is captured in an ionic, rather than Pt⁰ state. (Edge energies are measured at the maximum of the white line intensity.) Both PtO₂ and the photogenerated Pt—Fe·TiUNP show an approximate 7 eV blue shift from the foil, indicating formation of ionic Pt on Fe·TiUNP with no detectable metallic Pt generated. The edge-energy blue shift increases with increasing photodeposition time, consistent with increased Pt—O bond formation. Post 2 and 3-hour photodeposition samples indicate Pt more positively charged than either H₂PtCl₆ starting material or PtO₂.

FIG. 5A is data discussed in Example 1. A combination of H₂PtCl₆ and PtO₂ standards fits Pt—FeTiUNP XANES data well (R<0.01). Formation of PtO₂ suggests the following sequence during photosynthesis. H₂PtCl₆ physisorbs to FeTiUNP; photoexcitation activates formation of HCl leaving groups; subsequent replacement of the Pt—Cl bond by Pt—O bonding anchors Pt to the surface.

FIG. 5B is data discussed in Example 1. The Im part of the radial distribution plots of the EXAFS (extended x-ray absorption fine structure) spectra show growth of the characteristic Pt—O (left-most vertical dashed line) peak relative to that for Pt—Cl (middle vertical dashed line) with increasing photodeposition time from 0.5 hr to 3 hr. Photogenerated samples show no evidence for metallic Pt formation (right-most vertical dashed line). Spectra offset for clarity.

FIG. 6A is a plot of data from Example 1. XANES structure at the Fe K-edge for Fe·TiUNP, Pt—Fe·TiUNP, and Fe₂O₃ indicates bonding around Fe. The pre-edge feature at 7115 eV is greatly reduced in Fe·TiUNP compared with that in Fe₂O₃ indicating a quasi Oₕ environment for the Fe³⁺ ion in Fe·TiUNP. Capturing Pt on Fe·TiUNP blue-shifts the white-line edge consistent with the greater electronegativity of Pt relative to Fe. Catalytic cycling adds a pre-edge feature at about 7118 eV to the pre-cycle Pt—Fe·TiUNP indicating a stronger interaction between Fe and Pt.

FIG. 6B is a plot of data from Example 1. The first shell of Fe·TiUNP EXAFS R for Fe·TiUNP are well fit using a combination of scattering paths from hematite (Fe₂O₃) and the FeCl₃ precursor, suggesting that the Fe³⁺ ion is on the surface with chloride occupying some of the dangling valences.

FIG. 6C is a plot of data from Example 1. The first shell of Fe·TiUNP k-plots for Fe·TiUNP are well fit using a combination of scattering paths from hematite (Fe₂O₃) and the FeCl₃ precursor, suggesting that the Fe³⁺ ion is on the surface with chloride occupying some of the dangling valences.

FIG. 7 is a plot of data from Example 1. Radial scattering plots of Fe K-edge XAS for α-Fe₂O₃ (hematite), Fe·TiUNP, Pt—Fe·TiUNP pre- and post-formaldehyde catalysis. A peak appears at approximately 2.6 Å post Pt photodeposition; the intensity of this peak increases post-catalysis. Increasing intensity is consistent with localized deposition of Pt near the surface Fe defect. Energy released in the oxidation reaction enables Fe to adopt a more favorable and uniform configuration.

FIG. 8A is a plot of EXAFS fitting of Fe data for Fe·TiUNP post-photodeposition of Pt on 1:1, Pt—Fe·TiUNP radial plots.

FIG. 8B is a plot of EXAFS fitting of Fe data for Fe·TiUNP post-photodeposition of Pt on 1:1, Pt—Fe·TiUNP k-space plots. The hematite parameters that fit Fe·TiUNP do not match the Pt—Fe·TiUNP data well. Instead, adding a single scattering Fe—O—Pt path derived from Pt substitution in hematite Fe rather than Fe—O—Fe results in a reasonable peak-position fit of the obtained data. Bond lengths are uniformly slightly shorter than predicted by theory, likely due to increased oxidation of neighboring Pt.

FIG. 9 is a plot of data from Example 1. K-space plots of Fe K-edge EXAFS lend insight into particle size and particle growth during catalysis. Iron dopants in Fe·TiUNP, and Pt—Fe·TiUNP pre- and post-catalyst all lose signal after 7 Å⁻¹: 1.4 Å in direct space, reflecting the limited size of the ultra-nano particles and consistent with surface Fe. Crystalline Fe₂O₃ or Fe foil give signal at least out to 10 Å⁻¹. Neither Pt capture nor catalytic cycling result in particle growth: the photocatalyst is stable. Spectra offset for clarity.

FIG. 10 is an illustration of the general reaction mechanism of the photosynthesis reaction disclosed herein.

FIG. 11 is a plot for measuring nanoparticle size from UV-Vis. First derivative UV-Vis spectra of Fe·TiUNP (top) and post-photodeposition 14.2% Pt—Fe·TiUNP/85.8% Fe₁·TiUNP (bottom). Fe·TiUNP has a 318 nm band gap corresponding to a diameter of 1.61 nm. 14.2% Pt₁-Fei₁·TiUNP/85.8% Fe₁·TiUNP has a 324 nm band gap. Observed red shift is consistent with deposition of Pt.

FIG. 12 shows the effect of Pt loading on photocatalytic formaldehyde oxidation kinetics—controls and Pt deposition for <1 Fe: TiUNP: no catalyst (squares-top), Fe·TiUNP without Pt (circles-middle), and Pt nanoparticles synthesized from irradiation of Pt precursor (triangles-bottom). A mixture of SA Pt on Fe·TiUNP and undecorated Fe·TiUNP oxidizes 30% hr⁻¹.

FIG. 13 shows the effect of photodeposition time on photocatalytic activity. Initial concentration corresponding to 0.372 Pt per TiUNP was photo deposited for varying times onto 0.4% Fe₁TiUNP, then used in photodegradation of formaldehyde (C₀=1.67 mM). Single Pt atom capture increases from (top) 0 hr; (second from top) 2 hr; (bottom) 4 hr. Beyond 4 hr, Pt clusters form and photodegradation decreases (second from bottom).

FIG. 14 is Pt XANES data for Pt (0), (II), and (IV) standards. The standard data indicate that differentiation between Pt (II) and Pt (IV) is quite difficult, as the E₀ values measured are almost identical.

FIG. 15 is a plot of k-space spectra corresponding to the data of FIG. 5B. Pt foil, H₂PtCl₆, Pt(IV) oxide, and two deposition time k-space plots for reference. Window from 2.5 to 16.5, k-weight=2.

FIG. 16 is a plot of k-space spectra corresponding to the data of FIGS. 6A-6C. Window from 3-13, k-weight=1.

### DETAILED DESCRIPTION

Before the present invention is described in further detail, it is to be understood that the invention is not limited to the particular embodiments described. It is also understood that the terminology used herein is for the purpose of describing particular embodiments only and is not intended to be limiting. The scope of the present invention will be limited only by the claims. As used herein, the singular forms “a”, “an”, and “the” include plural embodiments unless the context clearly dictates otherwise.

Specific structures, devices and methods relating to generating single-atom catalysts are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, “ultra-nano” refers to particles that have a diameter of less than 2.5 nm and/or particles having fewer than 1000 formula units of TiO₂.

The present disclosure provides a photocatalyst. The photocatalyst is an ultra-nanoparticle that is composed primarily of TiO₂. The particle additionally has a single Fe, Co, Mn, Cr, or W atom constituting an engineered defect within the TiO₂. An engineered defect refers to a controlled, nonrandom reproducible defect. In some cases, the particle has a single Fe atom constituting the engineered defect within the TiO₂. In these cases, the single Fe atom is a single Fe(III) atom.

The photocatalyst includes a single metal catalyst atom bound proximal to the single Fe, Co, Mn, Cr, or W atom. Without wishing to be bound by any particular theory, it is believed that the binding of the single metal catalyst atom is via an oxygen atom bound to the single Fe, Co, Mn, Cr, or W atom (e.g., where SA represents the single metal catalyst atom and X is the single Fe, Co, Mn, Cr, or W atom, the binding is believed to be via SA-O-X binding). The single metal catalyst atom is bound in a positive oxidation state.

The ultra-nanoparticle has a diameter of between 0.8 nm and 2.5 nm. In some cases, the ultra-nanoparticle has a diameter of at least 0.8 nm, or at least 1.0 nm. In some cases, the ultra-nanoparticle has a diameter of at most 2.5, at most 2.4, at most 2.3, at most 2.2, at most 2.1, at most 2.0 nm, at most 1.9 nm, at most 1.8 nm, at most 1.7 nm, at most 1.6 nm. at most 1.5 nm, at most 1.4 nm, at most 1.3 nm, at most 1.2 nm, at most 1.1 nm, or at most 1.0 nm. The ranges defined by combining each of the lower limits and each of the upper limits articulated in these lists are expressly contemplated.

The ultra-nanoparticle contains between 20 formula units of TiO₂ and 1000 formula units of TiO₂, including but not limited to, between 50 formula units and 200 formula units. In some cases, the ultra-nano-particle contains at least 20 formula units of TiO₂, including but not limited to, at least 25 formula units, at least 30 formula units, at least 40 formula units, at least 50 formula units, at least 75 formula units, at least 90 formula units, at least 100 formula units, and at least 200 formula units of TiO₂. In some cases, the ultra-nano-particle contains at most 500 formula units of TiO2, including but not limited to, at most 400 formula units, at most 350 formula units, at most 300 formula units, at most 275 formula units, at most 250 formula units, at most 225 formula units, at most 200 formula units, at most 190 formula units, at most 175 formula units, at most 150 formula units, at most 125 formula units, or at most 100 formula units of TiO₂. The ranges defined by combining each of the lower limits and each of the upper limits articulated in these lists, with the exception of those where the lower limit is greater than the upper limit, are expressly contemplated.

The band gap is between 386 nm and 310 nm for particles between 2.5 nm and 0.8 nm. A person having ordinary skill in the art will appreciate that the present disclosure describes respective bandgaps and absorption properties that are associated with the various particle sizes described herein.

In some cases, the engineered defect is located in an energetically favorable portion of the particle, such as a [001] facet of the TiO₂. Without wishing to be bound by any particular theory, the evidence suggests that the energy difference between [001] the face and the [101] face (the other dominant face) is large enough that the single Fe, Co, Mn, Cr, or W atom is energetically driven to this face. However, it is also true that the ultra-nanoparticles described herein have facets that are less purely defined than facets in larger, more extensive crystalline structures. The evidence suggests that the single Fe, Co, Mn, Cr, or W atom is located in substantially the same position in all particles and the phraseology of this paragraph is intended to identify that reproducible location.

The single metal catalyst atom is selected from the group consisting of Pt, Pd, Ir, Ru, Rh, Os, Re, Au, Ni, Zn, and Cu.

In some cases, the TiO₂ is anatase form.

The photocatalyst can have any particle shape that allows the single metal catalyst atom and other properties described herein. In some cases, the photocatalyst substantially has a particle shape that is a truncated square bipyramid. In other words, the photocatalyst can have a shape that is substantially a truncated square bipyramid.

The photocatalyst disclosed herein has an oxidation reactivity that is at least an order of magnitude greater than a comparison particle that lacks the single metal catalyst atom but is otherwise identical to the photocatalyst. In other words, the photocatalyst has an oxidation reactivity that is at least an order of magnitude greater than an ultra-nano particle that is composed of TiO₂ and has a single Fe atom positioned as an engineered defect within the TiO₂, but which lacks the single metal catalyst atom.

In some instances, the photo efficiency is characterized with conversion of methanol to formaldehyde, a 2-electron oxidation. In some instances, the photo efficiency is characterized with oxidation of formaldehyde to CO₂ and H₂O, a 4-electron oxidation. In other instances, oxidation is characterized by degradation of methylene blue, or methyl orange, or other hydrocarbon. The photocatalysts described herein have improved photo efficiency when compared with particles that are lacking the single metal catalyst atom but are otherwise identical to the photocatalyst particles.

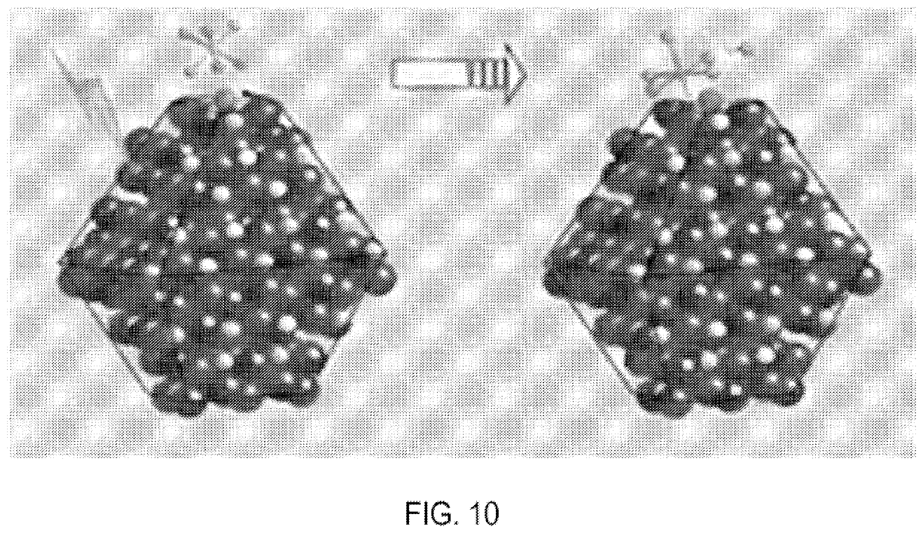

Referring to FIG. 10, an illustration of the general reaction mechanism is provided.

The present disclosure provides a composition. The composition includes the photocatalyst. The composition is typically a mixture of particles, some of which are the photocatalyst and some of which are other particles that are otherwise identical to the photocatalyst but lacking the single metal catalyst atom. The composition can be a solution and/or a liquid suspension.

From a practical standpoint, the particles described herein are far too small to be individually isolated and sorted to identify which particular particles contain the single metal catalyst atom and which do not, at least by current methods. Thus, in some cases where the photosynthetic reaction that deposits the single metal catalyst atom results in fewer than 100% of the particles containing the single metal catalyst atom, the resulting mixture of particles will have some proportion which have the single metal catalyst atom and some proportion which do not. In view of this reality, the yield of the reactions described herein is a lower limit and can be an important determining factor in the overall oxidative capabilities of the compositions produced. Similarly, the overall catalytic capabilities of a composition can be impacted by both the reactivity of the particles containing a single metal catalyst atom and their relative proportion.

In some cases, with single metal catalyst atoms having properties similar to Pt (including Pt itself, plus Pd, Ir, Ru, Rh, Os, Re, Au, Zn, and Cu), the compositions can be composed of at least 1% of the photocatalyst particles having the single metal catalyst atom, including but not limited to, at least 10%, at least 12.5%, at least 15%, at least 17% of the photocatalyst particles having the single metal catalyst atom. As far as an upper limit is concerned, that limit will typically be determined by reaction efficiencies and yields. In some of these cases, the compositions can be composed of 17% of the photocatalyst particles having the single metal catalyst atom.

In some cases, with single metal catalyst atoms having properties similar to Ni (including Ni itself), the compositions can be composed of at least 90% of the photocatalyst particles having the single metal catalyst atom, including but not limited to, at least 95%, at least 99%, or effectively 100% of the photocatalyst particles having the single metal catalyst atom.

One exemplary storage method includes removing the aqueous solution via evaporation and storing the particles as a crystalline solid comprised of ultra-nano particles and counter ions.

The present disclosure provides a powder including the catalysts and/or the composition disclosed herein.

The present disclosure provides a film. The film includes the catalysts and/or the composition disclosed herein. The film can be made by drop-casting the catalysts and/or the composition onto a substrate.

The present disclosure provides a method. The method includes: a) generating a plurality of ultra-nano TiO₂ particles, each having a single Fe, Co, Mn, Cr, or W atom positioned as an engineered defect within the particle; and b) photodepositing a single metal catalyst atom proximal to the single Fe, Co, Mn, Cr, or W atom for at least a portion of the plurality of ultra-nano TiO₂ particles, thereby resulting in a portion of the plurality of ultra-nano TiO₂ particles having a single Fe, Co, Mn, Cr, or W atom as the engineered defect within the particle and a single metal catalyst atom bound proximal to the single Fe, Co, Mn, Cr, or W atom.

The generating of step a) can be achieved by methods known to those having ordinary skill in the art, such as, for example, those described in Asong, N.; Dukes, F.; Wang, C.-y.; Shultz, M. J., The effect of iron doping on the adsorption of methanol on TiO₂ probed by sum frequency generation. Chemical Physics 2007, 339 (1-3), 86-93 and Dukes, Faith M.; Iuppa, Elizabeth; Meyer, Bryce; Shultz, Mary Jane, “Differing Photo-Oxidation Mechanisms: Electron Transfer in TiO₂ Vs. Iron-Doped TiO₂,” Langmuir 2012, 28, 16933-16940; DOI: 10.1021/1a303848g, which are incorporated herein in their entireties by reference.

The photodepositing of step b) involves irradiating the particles from step a) in the presence of single metal catalyst atom precursor, such as a solution containing ions of the single metal catalyst atom. The engineered-defect catalyst is irradiated in an oxygen saturated aqueous solution for 20 minutes to eliminate residual organic contaminants. Dissolved molecular oxygen is removed by saturating the solution with nitrogen. The single metal catalyst atom ion precursor is added, and the solution irradiated for up to 4 hr.

In the case of Pt, the photodepositing of step b) involves dispersing the particles from step a) into a H₂PtCl₆ solution and irradiating the solution with broad-spectrum light, while bubbling N₂ through the solution.

The methods described herein can produce the yields discussed above with respect to single metal catalyst atoms having different properties.

### Example 1

This example demonstrates the principle of this disclosed engineered defect strategy. Anatase titania ultra-nano particles (henceforth referred to as TiUNP) are the substrate. It has previously been reported that low-level Fe doping (optimal amounts are equivalent to 1 Fe:TiUNP) produces particles containing Fe atoms localized in the high-energy [001] face: hereafter denoted as Fe·TiUNP. The presence of Fe (III) creates an interband state (the Fe (III)/Fe (II) redox couple) that both stabilizes photogenerated electrons and forms an adduct with dissolved molecular oxygen. The stabilized electron potential is sufficient to reduce molecular oxygen but not water, avoiding competition with the hydrogen generation reaction and promoting surface charge transfer.

This example describes a photosynthetic method to leverage electron localization in Fe·TiUNPs to capture single atom (SA) Pt. The subsequent photo-oxidation efficiency of the SA catalyst is an order of magnitude (10-20×) greater than control Fe·TiUNP. Single-atom distributions of Fe and Pt are confirmed using CO-DRIFTS (carbon monoxide diffuse reflectance infrared Fourier transform spectroscopy) and XAS (x-ray absorption spectroscopy). The most active catalyst species contains one Pt atom and one Fe atom per TiUNP (explicitly denoted Pt—Fe TiUNP): 2.5 wt % Pt. Note that this is a significantly higher loading than other reported, metal oxide supported, single Pt atom catalysts and is obtained through a facile room-temperature photodeposition. A positive relationship between Fe doping, subsequent single-atom Pt loading and photo efficiency is observed. Proximal Fe and Pt bonding is detected via XAS, providing critical insight into both the photosynthesis mechanism and interactions between the Fe dopant and the captured Pt atom. The photosynthetic capture of single Pt-atoms via the engineered defect produces a catalyst that is stable even in the presence of chloride ions, which often promote metal nanoparticle (NP) formation.

The first portion of the example describes generation of the ultra-nano particle substrate including single-Fe-atom doping, kinetic characterization, and parameters used in CO-DRIFTS characterization. The second portion of the example includes particle size data and evidence that particles contain both single-atom Fe and single-atom Pt. Kinetic data indicates that the best Fe:Pt:TiUNP ratio is 1:1:1. Further, these SA-Pt decorated, SA-Fe doped particles are 10 to 20 times as efficient as SA-Fe particles. Photoefficiency (oxidations/photon absorbed) is about 35%; significantly more efficient than previously reported catalysts. The third portion of the example includes UV-Vis absorption data used to determine particle size, a comment about polydispersity, impact of Pt loading on formaldehyde oxidation, kinetic data showing the impact of Pt loading on activity, and XAS data on several standards.

### Fe·TiUNP Synthesis

Ultra-nano Fe·TiUNP (d<2 nm) is synthesized using two different procedures: an inorganic TiCl₄ synthesis of Dukes, et al., cited above, or an organic synthesis using titanium (IV) tetraisopropoxide, Ti(IsoP)₄. Both are found to produce identical results. The organic procedure is as follows. All glassware is cleaned with conc. sulfuric acid/NoChromix (Godax Laboratories) rinsed with 18 MΩ H₂O and oven dried. 1 mL of titanium isopropoxide (TTIP, Sigma, 33.8 mmol) is added dropwise to a sealed flask (sealed with a septum cap to exclude excess ambient moisture) containing 20 mL isopropanol (anhydrous, Sigma), 0.5 mL glacial acetic acid (anhydrous, Sigma, 87.4 mmol) and iron (III) acetylacetonate under vigorous stirring and held at 0° C. using a dry ice/water bath. Sufficient Fe (III) is used to achieve the targeted Fe:Ti mole ratio (0.42% and 1.0% in the current work). The subsequent TTIP solution is added dropwise into another sealed 0° C. (using a dry ice/water bath) solution consisting of 0.4 mL 18 MΩ H₂O, 0.2 mL 70% (15.7 M) nitric acid and 20 mL anhydrous isopropanol, stirring vigorously. The combined TTIP solution is added dropwise to a vigorously stirred, 0° C. solution of 300 mL 18 MΩ H₂O and 0.5 mL 70% (15.7 M) nitric acid. Slow dropwise addition of precursor solution in each step is key to a successful synthesis of size-controlled ultra-nano Fe·TiUNP. Cloudy or milky-white solutions indicate that nanoparticles have grown too large; the TiO₂ solution should remain clear throughout the synthesis process.

After sealed storage overnight at 4° C., the solution is dialyzed in a cellulose tubular membrane (Cellusep, 25 Å pore size) at 25° C. in 18 L bath of 18 MΩ H₂O, during which nanoparticles Ostwald ripen to 1-2 nm. pH is monitored every half hour, and dialysis continued to a pH of 2.0-2.2. The solution is evaporated in a rotary evaporator yielding ˜400 mg Fe·TiUNP nanopowder. UV-Vis spectra indicate that the Fe·TiUNPs are 1-2 nm before Pt photodeposition. Post-synthesis washing of UNPs is impossible due to agglomeration in organic solvents and complete dispersion in water; nanomaterial is cleaned of residual organics by UV irradiation before performing photodeposition of Pt or kinetic runs.

Passivation of the TiO₂ surface is critical both to arrest growth and to maintain solubility. Either low solution pH (<3) or organic capping ligands result in good stability. Low pH results in protonation of the anatase surfaces; Coulombic repulsion prevents agglomeration and particle growth. Capping with organic ligands prevents condensation also limiting particle size and stabilizing them. Increasing pH above approximately 3.5 or stray light that photo-oxidizes the organic capping ligands allows growth, turning the dispersion milky due to light scattering. Nanoparticles that scatter light can no longer be accurately sized using UV-Vis (d>8 nm)³³ and exhibit reduced photocatalytic activity.

### Particle Size Determination

Particle size characterization of ultra-small particles—those between 0.5 and 2 nm—via direct imaging methods such as TEM is challenging due to low contrast between the oxide and the 3d metal. Similarly, scattering techniques such as XRD blur due to a limited number of crystalline planes. In contrast, UV-Vis absorption is an effective tool to characterize semiconductor samples in this size range due to a blue shift from the bulk band gap. Brus first described widening of the band gap with reduced particle size due to quantum confinement as

$$Δ {E}_{g} = {E}^{*} - {E}_{g} ≅ \frac{{h}^{2}}{8 {R}^{2}} [ \frac{1}{{m}_{e}^{*}} + \frac{1}{{m}_{h}^{*}} ] - \frac{1.8 {e}^{2}}{ϵ R} ,$$

where ΔΕ_{g} is the change in band gap from bulk, R is the nanoparticle radius, m*ₑ and m*ₕ are the effective masses of the electron and hole, e is the electron charge, and ϵ is the permittivity. Brus' method can be accurate but depends on the choice of effective masses and permittivity; these values range widely in the literature rendering the method uncertain.

The method of Viswanatha (Viswanatha, R.; Sapra, S.; Satpati, B.; Satyam, P. V.; Dev, B. N.; Sarma, D. D., Understanding the quantum size effects in ZnO nanocrystals. Journal of Materials Chemistry 2004, 14 (4), 661-668) leveraged here, utilizes an empirical equation (ΔΕ_{g}≅100(18.1d²+41.4d−0.8)⁻¹, where ΔΕ_{g} is the change in band gap from bulk in eV and d is nanoparticle diameter. This method was first applied to TiO₂³⁶ and further developed for ZnO³⁴. The band gap shift, ΔΕ_{g} is determined from the energy at the inflection point of the absorbance curve (determined through the first or second derivative); a more systematic point than intersection of the tangent with the baseline. The Fe·TiUNP band gap is 318 nm (3.90 eV), corresponding to d=1.6 nm. (The SI includes a discussion of polydispersity.) After Pt photodeposition, the band gap slightly red shifts to 324 nm (3.83 eV). A size of 1.6 nm corresponds to approximately 96 TiO₂ formula units. The most highly active 1% Fe·TiUNP doping level indicates an average of 1.0 Fe atoms/particle.

Determining the band gap via UV-Vis absorption both provides a basis for calculation of the average number of photodeposited Pt atoms and helps confirm successful Pt deposition. After Pt photodeposition (FIG. 11) the band gap decreases by 6 nm signaling successful Pt capture. Comparison of the wider first derivative peak for post-photodeposition Pt—Fe·TiUNP to the narrower peak for pre-photodeposition catalyst indicates a wider distribution of sizes after Pt deposition. These observations are in good agreement with the calculation of approximately 0.17 Pt per particle.

Note that the per-particle Fe content reported here is comparable to that reported in past work. This past work concluded that 0.5 mol % Fe·TiUNP (1 Fe:200 Ti) exhibited a higher photocatalytic activity than the 1.0 mol % Fe·TiUNP (2 Fe:200 Ti). However, the TiO₂ particles reported here are, on average, 1.5 nm: slightly smaller than 2.0 nm reported by Dukes, et al. The larger particles previously reported contain approximately twice the number of TiO₂ formula units as the d=1.5 nm TiO₂ discussed in this example. Thus, on a per-particle basis, 0.5 mol % Fe on d=2.0 nm TiO₂ is the same iron content as 1.0 mol % Fe on d=1.5 nm TiO₂: both catalysts contain approximately 1 Fe atom per particle.

### SA Pt—Fe·TiUNP Photocatalyst Synthesis

Atomically dispersed Pt—Fe·TiUNP is produced by dispersing the Fe·TiUNP nanoparticles in H₂PtCl₆ solution and irradiating with a broad-spectrum 1000 W Hg-Xe arc lamp (Oriel model 66921). 50 mg Fe·TiUNP nanopowder is added to 12.5 ml water acidified with two drops of 70% (15.7 M) nitric acid. The Fe·TiUNP mixture is added to a cylindrical reactor fitted with CaF₂ windows. The reactor is placed in a water bath and irradiated while O₂ gas is bubbled through the solution at a rate of 15 SCFH. Intensity of the arc lamp is quantified with a ScienTech® meter and detector (ScienTech® 365 power and energy meter, ScienTech® 36-0001 detector) placed 0.5 m from the light source: 3.5 W without reactor and water bath in the light beam. Irradiation through an IR water filter reduces IR heating. Irradiation of the solution during O₂ bubbling serves to rid the nanoparticle catalyst of residual organic compounds from the synthesis. After 20 min, the lamp is blocked and O₂ bubbling stopped. 12.5 mL aqueous H₂PtCl₆ solution with varying Pt concentrations is added to the Fe·TiUNP solution. It is imperative to keep the initial Pt:Fe·TiUNP ratio lower than 1 to favor formation of SA Pt over Pt NPs. N₂ is bubbled through the combined solutions at a rate of 15 CFPS. After 20 minutes N₂ bubbling, the lamp is re-exposed and N₂ bubbling continued for 4 hr. irradiation. An initial ratio of 0.4 Pt: TiUNP results in approximately half of the Pt photodeposited as assessed via ICP of supernatant. Washing of nanomaterial after photodeposition is impossible due to the ultra-nano size of the TiUNP. Nanopowder obtained through rotary evaporation of photodeposition solution redisperses into transparent solution on attempted washes.

### Photocatalytic Kinetics

The lamp is blocked and 8.3 mL of 6.67 mM (200 ppm) aqueous H₂CO solution added to a final concentration of approximately 1.67 mM (50 ppm). 1 mL is withdrawn to obtain an initial H₂CO concentration (C₀) and O₂ is rebubbled through the reactor at 15 CFPH. After 10 min, the solution is re-exposed to the arc lamp and 1 mL samples are withdrawn every 30 minutes for 120 minutes. Aliquots are analyzed by a variant of a standard EPA formaldehyde protocol: treat with 0.5 mL 0.75 M Na₂HPO₄, sit for 30 minutes, and centrifuge to precipitate TiUNP particles. 0.4 mL of the resulting solution is extracted, added to 2.5 mL of 0.25 g/L O-(2,3,4,5,6-Pentafluorobenzyl)hydroxylamine (PFBHA) solution, and allowed to complex overnight. The PFBHA-HCHO product is partitioned into 1 mL of hexane/1-2 difluorobenzene internal standard (0.3 mL 1-2 DFB/1 L hexane) and analyzed using GC-FID.

### CO-DRIFTS Parameters

Diffuse reflectance infrared Fourier transform spectroscopy (DRIFTS) measurements (Nicolet iS50 FTIR spectrometer equipped with a DTGS KBr detector and a Harrick praying mantis HVC-DRP4 high temperature reaction cell equipped with ZnSe and quartz windows) characterize Pt on the particles. Post formaldehyde photo-oxidation, the catalyst solution is evaporated via rotary evaporator to obtain the used Pt—Fe. TiUNP nanopowder. The nanopowder loaded DRIFTS cell is heated to 250° C. under He flow. At this temperature, the gas is switched to a 5% H₂/He mixture flowing at 12 mL/min for 30 minutes. After reduction, the sample is purged with pure He gas at 250° C. for 10 min and cooled to room temperature under He flow (20 mL/min). A background spectrum is recorded at room temperature under He flow. A mixture of 20% CO in He is introduced for 30 minutes at a flow rate of 10 mL/min and adsorption spectra recorded under CO flow. The cell is purged with He for 30 minutes and desorption spectra recorded at approximately 1-minute intervals.

### X-ray Absorption Spectroscopy

X-ray Absorption Spectroscopy was performed at the APS, Argonne National

Laboratory. Fe K-edge data were acquired at beamline 12-BM-B, utilizing bending magnet radiation, fluorescence detection mode and a Si [111] monochromator. Pt L₃ edge data were obtained at beamline 16-BM-D, utilizing bending magnet radiation, transmission detection mode and a Si [111] monochromator. Pt L₃ spectra were calibrated to the E₀ of a Ta reference foil measurement bracketing the sample acquisition, while Fe K-edge spectra were calibrated using Fe reference foil run simultaneously with sample. E₀ of Fe foil standard was fixed at 7112.0 eV at the first inflection point; E₀ of Ta foil standard was fixed at 11681.5 eV in a similar manner. Resolution of both Fe K-edge and Pt L₃-edge spectra is 0.2 eV in the XANES/EXAFS region. Nanomaterial was obtained by simple rotovaping of TiUNP solution post-photocatalysis. Nanopowder was spread as thin layers on Scotch tape and folded for XAS acquisition. Both Fe K-edge and Pt L₃-edge samples were monitored after positioning and before spectrum acquisition for approximately 5 minutes to assess changes in XAS spectra. Neither Fe or Pt sample spectra exhibited any change during monitoring and remained stable over multiple scans, indicating samples were not substantially degraded by the beam during the acquisition period. Ravel and Newville's DEMETER package was used for processing and fitting of XAS spectra.

### Results and Discussion

Photosynthesis of the SA-Pt photocatalyst begins with generation of an ultra-nano titania platform. This section begins with a discussion of this platform. Ultra-nano TiUNP supports regular placement of an Fe dopant in the high-energy [001] facet. The resulting localization of a photo generated electron enables the capture and stable anchoring of single atom Pt through formation of Pt—O bonds. Detection of successful SA capture uses CO-DRIFTS and XAS; these data are discussed after presentation of kinetic data demonstrating the high efficiency of the catalyst. Mass balance (data presented in the SI) indicates a 17% yield of Fe-TiUNPs containing SA Pt. Combining yield and catalytic efficiency data shows that the resulting catalyst is ˜35% efficient (efficiency defined as photooxidation events/photons absorbed).

### Platform Generation

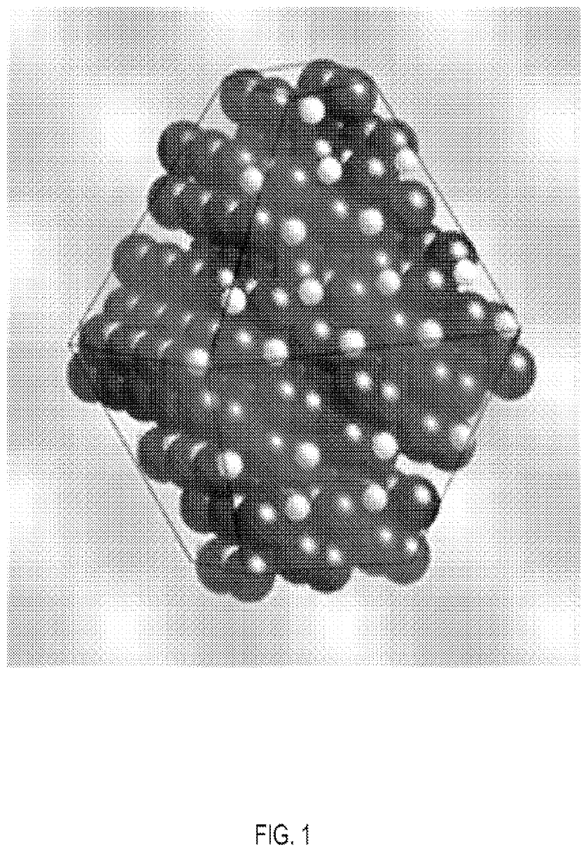

Synthesis of Fe·TiUNP generates consistent batches of nanomaterial, ideal for robust kinetic studies as well as formation of stable SA sites. The ultra-nano Fe·TiUNP utilized in this work is synthesized according to two methods: that of Dukes, et al., cited above, from TiCl₄ or from Ti(IsoP)₄. With TiCl₄, the TiUNP size is limited due to generation of 4 equivalents of HCl per hydrolyzed TiCl₄. Low pH results in positively charged TiUNP clusters; aggregation during Ostwald ripening is thus opposed by Coulombic repulsion. With Ti(IsoP)₄, nitric acid and organic ligands limit size. In both methods, dialysis gradually reduces [W^{+],} mitigating surface charge, and allowing controlled ripening to the desired size. The Fe dopant is preferentially located in the [001] facet due to minimizing surface free energy. Fe·TiUNP size is determined via UV-Vis measurement of the band gap (FIG. 11): due to quantum confinement the band gap increases as a function of shrinking nanoparticle size. Typical particles size to d=1.5±0.2 nm: termed ultra-nano. Particles contain approximately 100 TiO₂ formula units (MW TiUNP: ˜8000 g/mol) and are shown schematically in FIG. 1. Micro Raman analysis confirms that the phase of FeTiUNPs is anatase; a hematite Fe₂O₃ phase appears only in samples containing >1.0 Fe per TiUNP. This is consistent with literature findings in which Fe³⁺ dopant incorporates into Ti⁴⁺ vacancies in the anatase lattice.

The Fe·TiUNP particles present a unique, facile platform for SA Pt capture. The Fe dopant-defect not only has the potential to capture Pt or other SA metals of interest but also suppresses transfer of the photogenerated electron to water. As a result, irradiation of Fe·TiUNP in de-oxygenated water eliminates ·OH generation and subsequent homogeneous reaction^{28,29}. Lacking a destination for the photo generated electron, direct hole transfer is inhibited, and photo-oxidation is quenched. The implication for a photo irradiated, deoxygenated PtCl₆²⁻ (via H₂PtCl₆) solution is that homogeneous generation of Pt clusters is kinetically limited. Further, there is a Coulombic attraction between the negatively charged PtCl₆²⁻ ion and the positively charged Fe·TiUNP particle. Localization of the photo generated electron at the Fe site and its attraction to the more electronegative Pt supports capturing Pt proximal to the Fe.

### Pt Capture

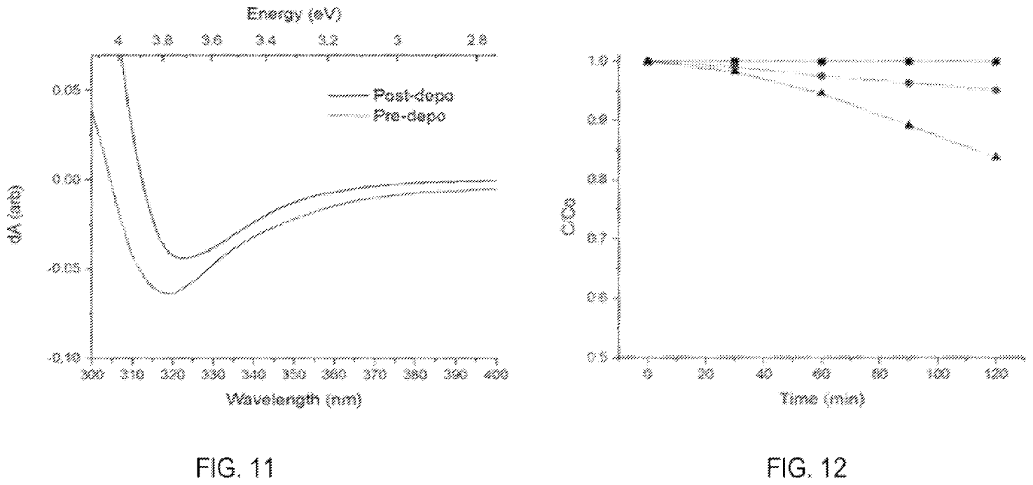

Critically, for this particular reaction, the presence of the Fe dopant is required to simultaneously capture high loading SA Pt and quench Pt cluster formation (FIG. 12). Irradiation of solutions containing the Pt precursor with undoped TiUNP generates Pt clusters on TiUNP; irradiation of solutions without TiUNP homogeneously generate Pt clusters. Both oxidize formaldehyde. However, the reactivity of Pt clusters added to an Fe·TiUNP solution is significantly less than that of Pt-Fe TiUNP obtained via photodeposition. No rate enhancement occurs unless the Pt species is atomically captured by the particles via photosynthesis.

### Discussion of Fe and Pt Doping

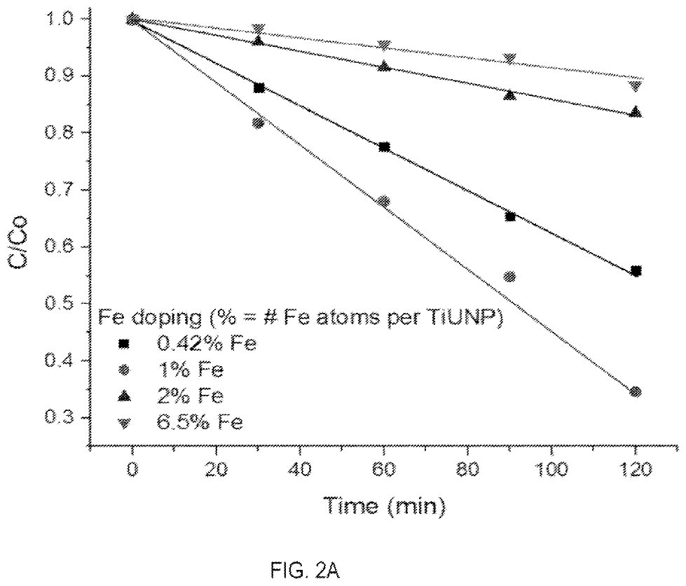

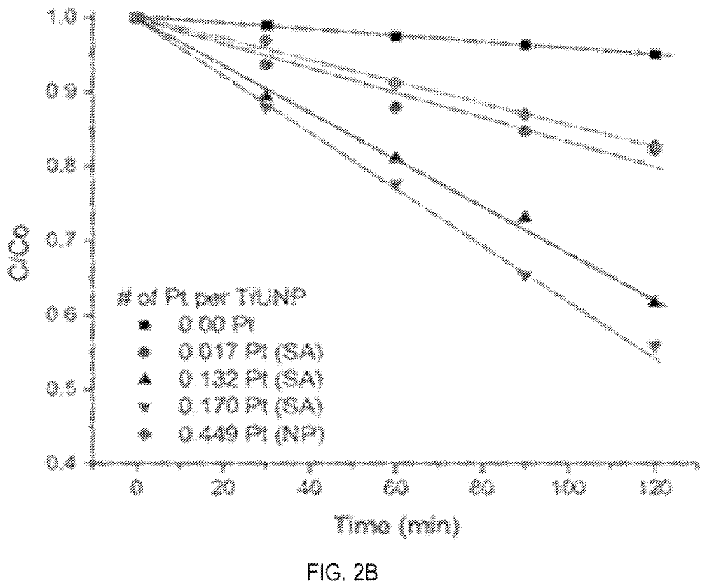

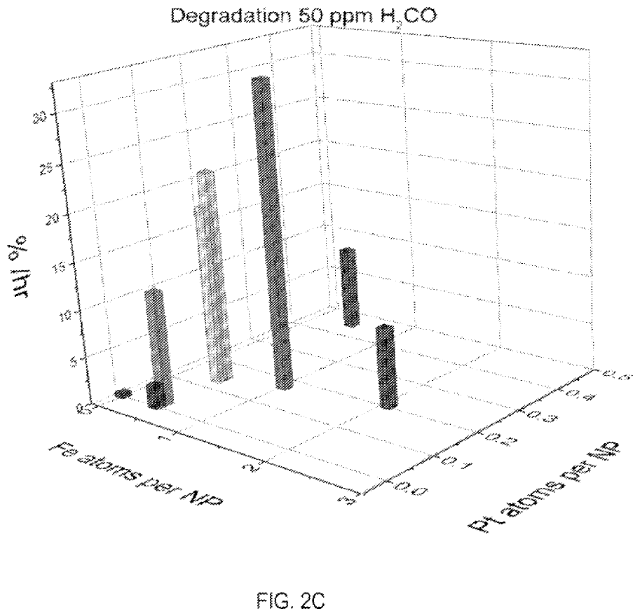

Varying levels of Fe dopant and Pt deposition significantly impact charge recombination dynamics and thus reactivity; incorporation of both results in a much more efficient photocatalyst than TiUNP with either dopant alone (FIG. 2C). The most efficient catalyst found has an overall distribution of 1 Fe atom per particle (FIG. 2A) and 0.17 Pt atoms (FIG. 2B). In the case of Fe in the presence of a fixed initial Pt concentration (FIG. 2A), Fe doping increases activity up to a level of 1%, or a distribution of about 1 iron atom per TiUNP (˜100 TiO₂: 1 TiUNP). The presence of multiple Fe centers causes significant decline in the rate of formaldehyde oxidation. This finding is consistent with previous work by Dukes, et al. which found that optimal rate enhancement for methanol oxidation was also obtained with particles containing up to 1 Fe atom. This is because single Fe³⁺ sites sequester and stabilize the photogenerated electron via reduction to Fe²⁺. In contrast, multiple Fe³⁺ centers obtained in higher levels of doping form a hematite phase which promotes electron-hole pair recombination, a process that competes with formaldehyde oxidation.

Enhancements in photocatalytic activity are observed when single Pt atoms are captured by Fe·TiUNP (FIG. 2B) containing 1 Fe atom. Even very low levels of photocapture result in significant improvements. The 0.017 Pt: Fe·TiUNP (red, only about 2% of Fe·TiUNP contain Pt) degrades almost four times as much formaldehyde in 60 minutes as the Fe·TiUNP control. The most active photocatalyst contains the highest quantity of atomically dispersed Pt and Pt₁-Fe₁·TiUNPs: 0.17 Pt: Fe·TiUNP (magenta). Increasing the initial Pt concentration beyond about 0.4 Pt:TiUNP results in formation of Pt NPs (green). Thus, a critical component of successful SA photodeposition is to strongly limit the amount of initial Pt added.

Pt NP formation harms total activity. The combination of Pt NPs and Fe·TiUNP degrades slightly less formaldehyde than 0.017 Pt: Fe·TiUNP, which contains only a very small amount of hybrid Pt—Fe·TiUNP. Single atoms of Pt on Fe·TiUNP are a much better catalyst for formaldehyde photooxidation than are Pt NPs on the same support. Single atoms of iron combined with single atoms of Pt yield the best photocatalyst: hybrid Pt₁-Fe₁·TiUNP. The conclusion is thus: clustering of either Pt or Fe dopant harms total activity.

### Photo-Oxidation Efficiency for Hybrid Single Atom Pt—Fe·TiUNP

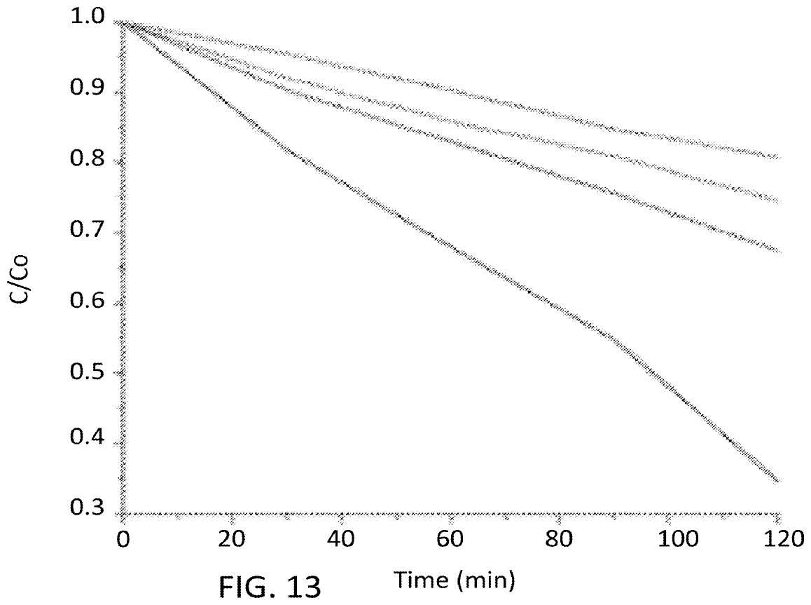

Absent Pt atoms, the maximum degradation of formaldehyde is 2.5%/hr.; this occurs with particles that have 1 Fe atom per particle. Incorporation of Pt enhances the photo-oxidation efficiency, reaching a maximum when the particles have 1 Fe atom and an average of 0.17 Pt atoms per particle (FIG. 2C). (More detailed experimental data can be found in FIG. 12, FIG. 13, and FIG. 2). This suggests that 83% of the post-photodeposition particles are simply starting material Fe·TiUNP; 17% consist of hybrid SA product Pt—Fe·TiUNP.

Reaction conditions are photon limited (e.g. FIG. 2 time plots are linear). Photons absorbed by Fe·TiUNP degrade 2.5% of the initial formaldehyde per hour, and 83% of the photons are absorbed by Fe·TiUNP. Assuming that photon absorption is unimpacted by the presence of Pt—Fe·TiUNP, Fe·TiUNP accounts for about 1.9% of the observed degradation; the remaining is due to photons absorbed by Pt—Fe·TiUNP. Photons absorbed by Pt—Fe·TiUNP thus degrade 14.8 times as much formaldehyde as those absorbed by Fe·TiUNP. Since the photoefficiency of Fe₁·TiUNP is 2-3%, Pt₁-Fe₁·TiUNP is about 35% photo efficient (SI Calculation 1).

Pt Characterization

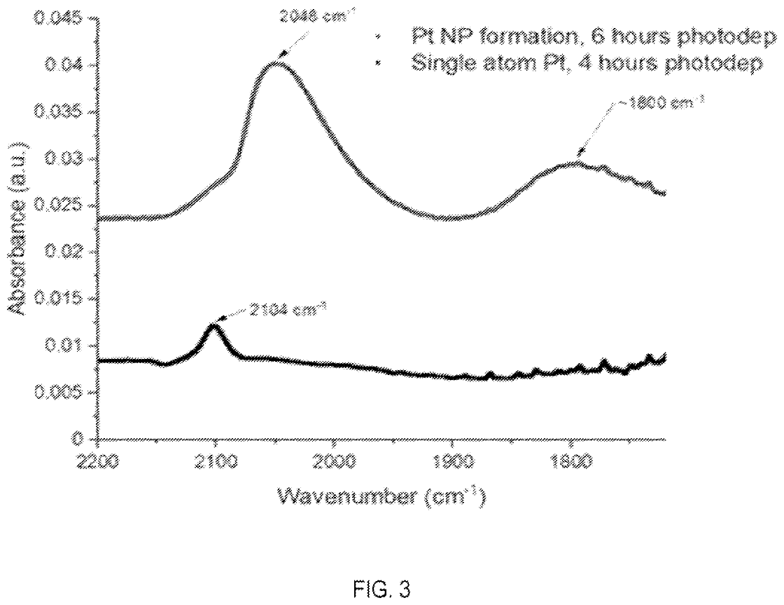

A diagnosis of the clustering state and partial charge of SA Pt is based on a large, comprehensive body of UHV (ultra-high vacuum) work (Table 1) characterizing interaction of CO with Pt surfaces. CO-DRIFTS (diffuse reflectance infrared Fourier transform spectroscopy) data (FIG. 3) shows that atomically dispersed Pt is produced with photodeposition times up to 4 hr; longer deposition times produce Pt clusters. CO linearly bound to a partially positive ionic Pt surface species is characterized by a single, sharp-CO peak at 2104 cm⁻¹, CO bonded to Pt(0) produces a peak at 2048 cm⁻¹, while CO bridge bonding in Pt clusters exhibits a broad resonance at 1800 cm⁻¹ (FIG. 3). Post-catalytic cycling data (FIG. 3, bottom trace) indicate that 4-hr photodeposited Pt remains atomically dispersed after the catalytic cycle. In contrast, photodeposition times longer than 4 hrs (6 hrs in FIG. 3, top trace) show both the signature of Pt(0) at 2048 cm⁻¹ and a broad absorbance at 1800 cm⁻¹, both characteristic of Pt cluster formation. Therefore, the photoreduction of H₂PtCl₆ to Pt(0) NPs competes with photodeposition of SA Pt, with longer photoirradiation times favoring NP formation.

TABLE 1
CO-DRIFTS Characteristic CO—Pt IR features
and associated binding configuration.

| | | Present | Present |
|---|---|---|---|
| CO-peak (cm⁻¹) | CO—Pt configuration | in 4-hr? | longer? |
| 1800 | CO—Pt bridge | No | Yes |
| 2048 | linear CO—Pt(0) | No | Yes |
| 2104 | CO—Pt^{δ+} | Yes | Shoulder |

SA Pt—Fe·TiUNPs utilized in a 2 hour formaldehyde oxidation kinetic run (FIG. 3, bottom trace) show a relatively narrow, 10 cm⁻¹ FWHM (full width half maximum) peak, indicating not only that Pt is single atom but also that the Pt atoms occupy relatively uniform surface sites. The combined absence of CO bridge bonding peaks and presence of a strong, narrow CO signal suggests that this synthesis is strongly selective for site-specific, single-atom Pt. Furthermore, SA Pt sites that were used for photo-oxidation reactions are stable when heated at least to 250° C. during DRIFTS pre-treatment (see above). Kinetic data in FIGS. 2A-B are linear over the ˜500 oxidation events per particle occurring in a typical two-hour run (reaction is photon limited). Therefore, the single atom Pt photo capture reported here yields stable active sites even in the presence of significant residual chloride.

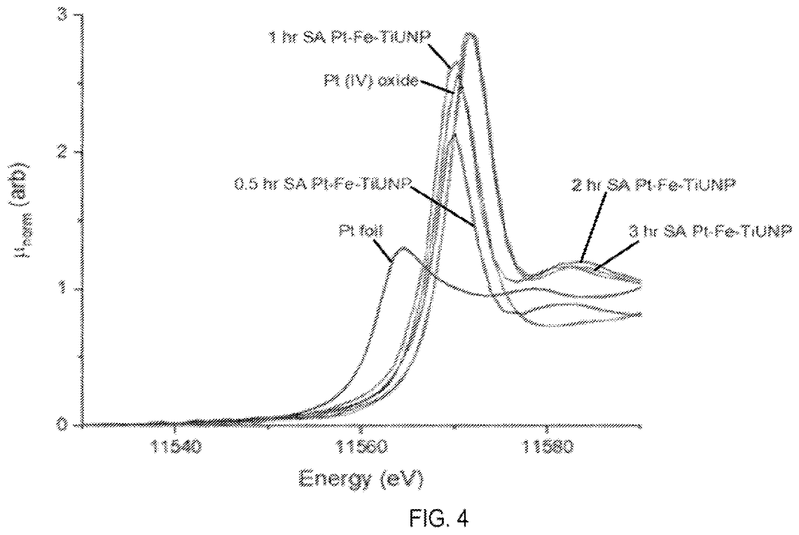

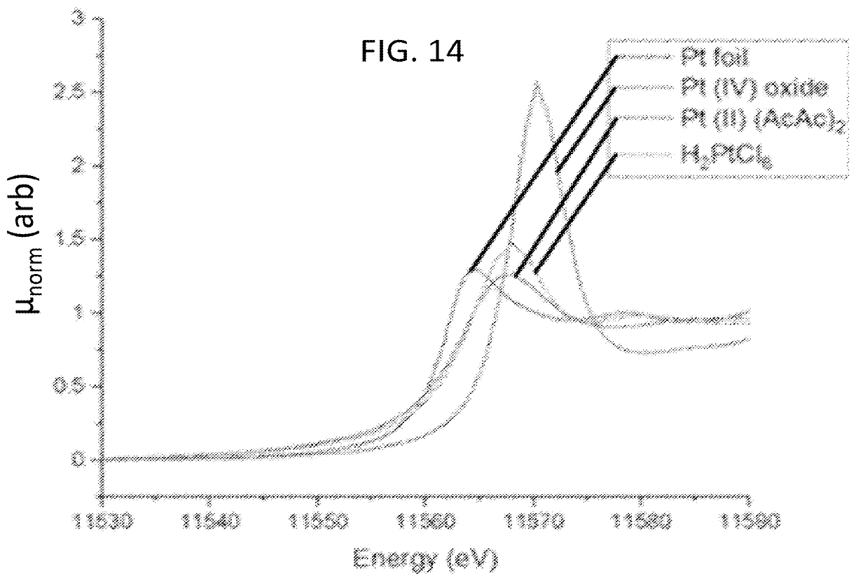

XANES (x-ray absorption near edge spectroscopy) at the Pt L₃ edge (FIG. 4) lends further insight into both the Pt oxidation state and the ligands surrounding photodeposited Pt. The steeply rising edge energy is sensitive to the oxidation state due to valence electron penetration into the core that is removed upon oxidation. Pt L₃ E₀ values, measured at the maximum intensity of the white line, indicate Pt is in a positive oxidation state. Since Pt XANES uses the L edge, positive Pt is easily distinguished from Pt (0), but Pt (II) and Pt (IV) standards indicate the edge is relatively insensitive to the precise positive value (FIG. 4, FIG. 14). The data in FIG. 4 show that the E₀ values for all deposition times are near to that of Pt (IV) (particles are labeled with their deposition times). The lack of any rising edge feature around 11564 eV in Pt—Fe·TiUNP further confirms the CO-DRIFTS conclusion: no Pt clusters form. E₀ at 0.5 hours begins at 11570.0 eV, approximately that of the H₂PtCl₆ starting material. At 1 hour E₀ increases by about half an eV to 11570.4 eV. As more Pt is photodeposited, E₀ climbs to 11571.3 eV. A blue shift of 0.9 eV in 1-hour deposition indicates formation of a species more positively charged than Pt in either H₂PtCl₆ or PtO₂ standards. Also notable is the significant increase in white line intensity as photoirradiation time increases, with 1-hour spectra comparable to PtO₂ standard and 2 and 3 hour spectra even more intense. These observations are consistent with oxidized Pt atoms vicinal to Fe³⁺, an oxidized neighbor that is not present in Pt (IV) standards.

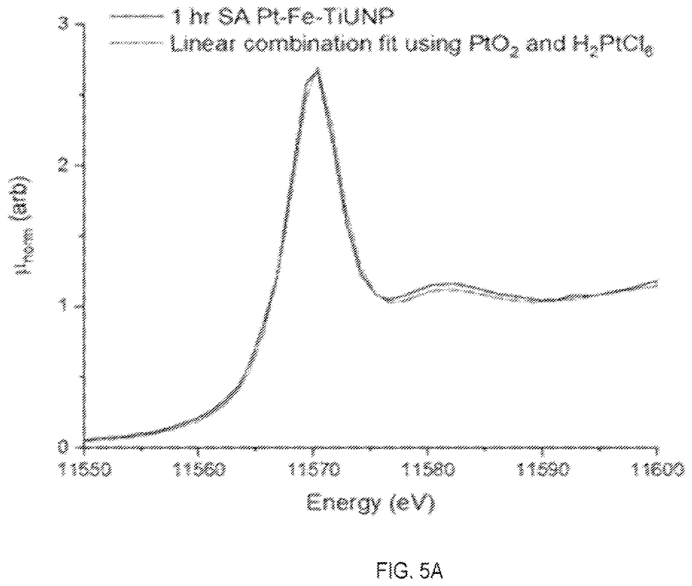

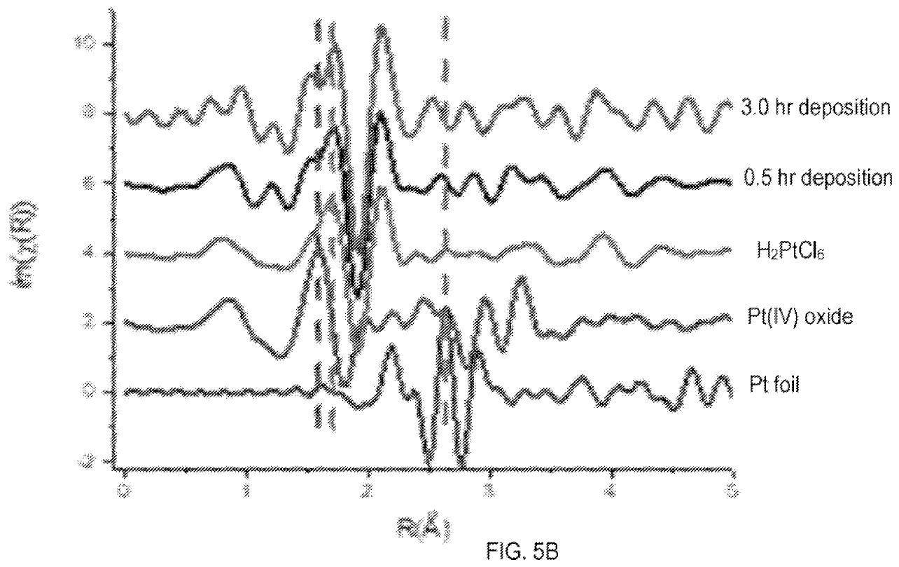

The Pt L₃ edge spectra of Pt-Fe TiUNP with photodeposition times of 0.5, 1, 2, and 3 hours (Table 2) was fit with a linear combination of H₂PtCl₆ and PtO₂, allowing edge energies to vary. This was allowed because the shift is small and due to increasing vicinal photodeposition of Pt next to the ionic Fe dopant, which pulls electron density away from Pt. A separate chemical species is not being formed; statistics of the fit remain strong (R<0.05) using only these two references. Strong fits (R<0.01) were obtained using a combination of reference spectra of these materials; a representative for the 1 hour data is given in FIG. 5A. Inclusion of the Pt foil standard degrades the fit. At 0.5 hours approximately 8.2% of Pt in the Pt—Fe·TiUNP is in the form of PtO₂, increasing to 14.3% at 1 hour and 19.4% at 2 hours of photodeposition time. At 3 hours of photodeposition, approximately 30% of Pt is in the form of PtO₂, corroborating results of ICP monitoring of photodeposition progress (Table 3 below). EXAFS radial scattering plots of Pt—Fe·TiUNP (FIG. 5B) further confirm Pt—O formation: a Pt—O peak at approximately 1.7 A appears in Pt—Fe·TiUNP samples and increases intensity from 0.5 hr to 3 hr. The Im part of the radial scattering plot is very informative when multiple scattering paths nearly overlap. FIG. 5B shows the Im part of the radial scattering plot for a 0.5 and 3.0 hr Pt photodeposition on Fe·TiUNP. Conspicuously, neither photodeposition time shows any evidence of Pt—Pt bonds that are clearly shown as a 2.7 A peak (marked with right-most vertical dashed line) corresponding to the closest Pt—Pt distance in metallic Pt. Both the 0.5 and 3.0 hr spectra show the impact of interference between a Pt—O scattering at 1.6 Å—shown in the PtO₂ plot (marked with left-most vertical dashed line)—and a Pt—Cl scattering at 1.7 Å—shown in the green H₂PtCl₆ plot (marked with middle vertical dashed line). Interference makes the oxide peak appear slightly red-shifted due to riding on the stronger Pt—Cl peak.

TABLE 2
Pt—Fe•TiUNP XANES Pt L₃ combination fit.

| Photodep. | | | |
|---|---|---|---|
| time (hr) | H₂PtCl₆ wt | PtO₂ wt | % PtO₂ |
| 0.5 | .918 | .082 | 8.2% |
| 1 | .857 | .143 | 14.3% |
| 2 | .794 | .206 | 20.6% |
| 3 | .691 | .319 | 31.9% |

### Stability of Atomic Pt Sites

Leveraging metal-support interactions (MSI) such as Pt—O bonding is one common method for stabilizing SA dispersions. Strong electrostatic interactions with reducible supports such as TiO₂ stabilize Pt^{δ+} by increasing the activation barrier for reduction of positively charged single atoms to metallic Pt⁰. The positive charge opposes nanoparticle formation in the absence of external Pt clusters. The blue-shifted linear CO—Pt peak in CO-DRIFTS indicates the presence of dispersed Pt^{δ+} species, symptomatic of enhanced electron transfer to the TiO₂ support. Electronegative Pt^{δ+} likely magnifies Fe stabilization of the photogenerated electron by enhancing localization of the electron on vicinal Fe, resulting in enhanced electron-hole pair separation and reduced recombination rates.

### Fe Characterization

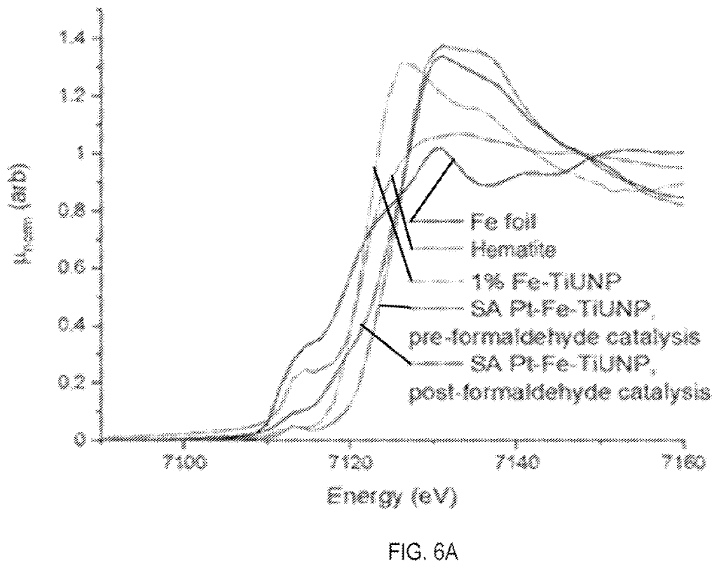

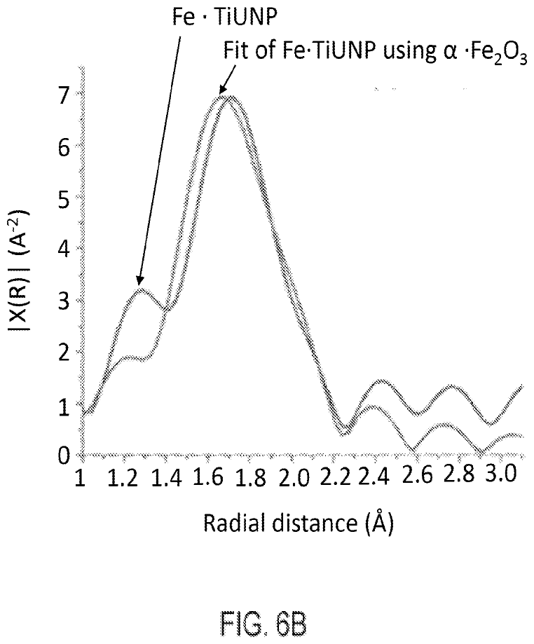

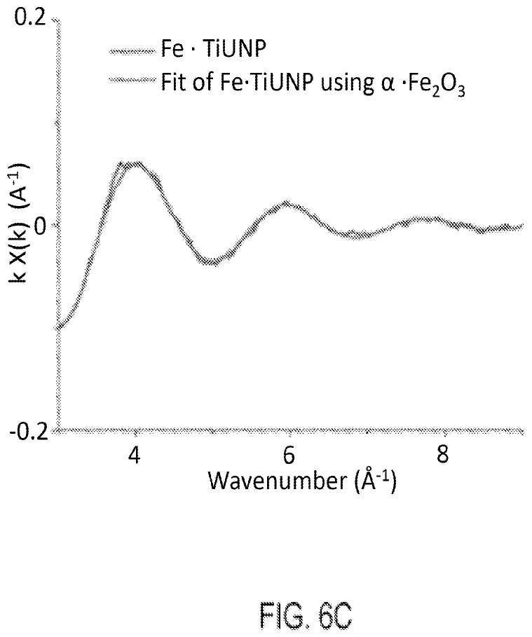

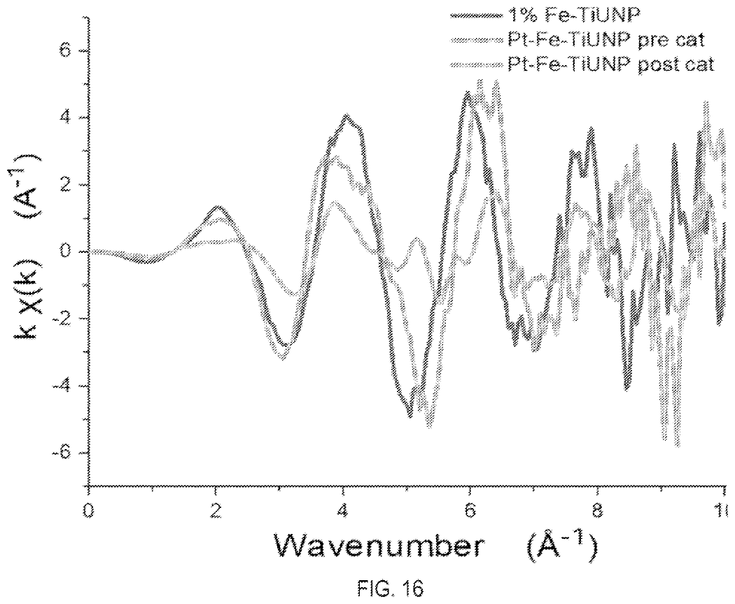

Further support for possible interactions of vicinal Pt with Fe can be found through analysis of Fe K-edge XAS of Pt—Fe·TiUNP. Since characterization of Fe uses the K-edge, it is more sensitive to the oxidation state. The XANES energy (FIG. 6A), radial (FIG. 6B), and k-weight (FIG. 6C) spectra of Fe·TiUNP compared with that of hematite Fe₂O₃ shows similar edge energies, indicating that Fe is in the +3 oxidation state in both particles. For reference, k-space plots are also provided in FIG. 16. Pre-edge features are due to a 1s→3d transition; a transition that is forbidden in an environment with inversion symmetry. The pre-edge absorption at 7115 eV is diminished in Fe·TiUNP compared with that of Fe₂O₃. This weakening and slight broadening of the 7115 eV peak in the catalyst is likely due to incomplete, somewhat amorphous coordination of O atoms around the Fe dopant: depending on where Fe³⁺ is localized in anatase [001] varying coordination shells of both O and Cl are possible. These deviate substantially in structure from the octahedral, full O-coordination found in Fe₂O₃.

Photodeposition of Pt significantly modifies the Fe XANES, increasing E₀ by 4 eV to 7126.5 eV indicating further loss of electron density on the Fe dopant. This observation is consistent with deposition of ionic Pt vicinal to the Fe: the more electronegative, positively charged Pt atom is expected to pull electron density away from Fe³⁺. The blue shift is maintained after catalytic cycling: iron remains in a +3 oxidation state. A broad, as-yet unidentified pre-edge absorption at about 7118 eV appears after catalytic cycling. We conjecture that this feature gains intensity due to distortion by the relatively large Cl⁻ ligand or results from residual formaldehyde partially coordinated to the positively charged Fe site.

The first shell of Fe·TiUNP EXAFS is fit using the DEMETER program package by combining two scattering paths: Fe—Cl from FeCl₃ (N=1, R=2.375 A) and Fe—O from hematite (N=3, R=1.976 A). Fourier transform and windowing parameters for the fitting are as follows: forward transform k from 3.0 to 12.843, Hanning windowing, backward transform R from 1 to 3, Hanning windowing. All fits were Hanning windowed from R=1-3. Residual chloride from the synthesis is expected since Fe·TiUNPs are collected as a stable chloride salt and FeCl₃ is used as the iron precursor. Hematite Fe—O paths with total N>3 fit Fe·TiUNP data poorly, suggesting undercoordinated Fe dopant sites. This finding is consistent with localization of Fe dopant on the surface of TiUNP, further supporting the suggestion that Fe (III) incorporation stabilizes the [001] facet. Hematite Fe—O—Fe paths also degrade the fit, suggesting single atom Fe rather than oxygen-bridged Fe sites. No metallic Fe·Fe peak at R=2.6 A is observed, further indicating atomically dispersed Fe sites. The iron precursor FeCl₃ is incorporated fully as atomically dispersed Fe (III) into TiUNP during the UNP synthesis without such byproducts as Fe NPs.

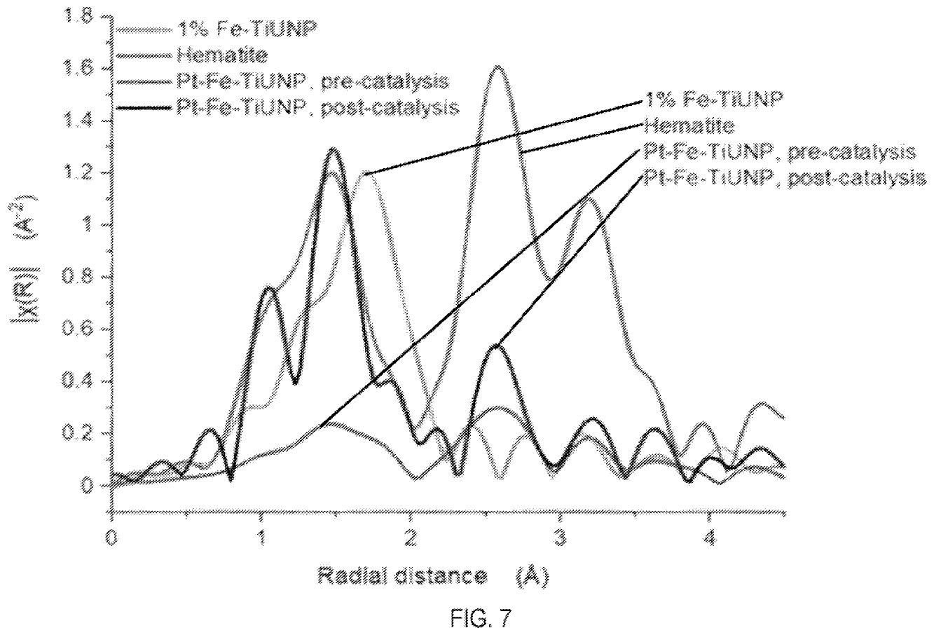

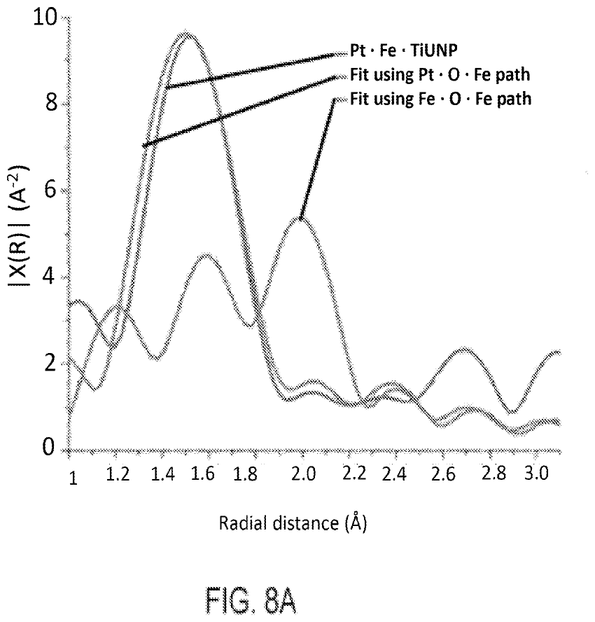

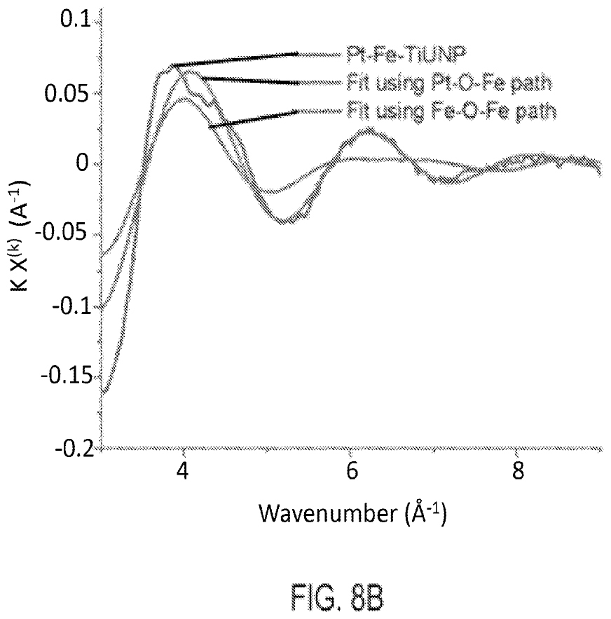

Additional analysis of Fe EXAFS supports the hypothesis of vicinal deposition of Pt near Fe, validating interpretation of XANES. A signal at 2.6 Å (FIG. 7) not present in the 1% Fe·TiUNP starting material R-plot emerges after the initial photodeposition of Pt and increases in intensity post-photocatalysis. Similar distances have been reported in single atom literature as oxide-bridged heterogenous metal-metal signals: Fe—O—Ni in particular. In order to examine this possibility and eliminate formation of an Fe₂O₃ phase during catalysis, two EXAFS fits of the scattering (FIG. 8A) and k-weight (FIG. 8B) spectra of pre-catalysis Pt-Fe. TiUNP were performed. Using the parameters outlined above for Fe·TiUNP, one of two additional fits were added to the initial fit, which no longer describes Pt—Fe—TiUNP data well. The first fit adds a hematite oxide-bridged Fe—O—Fe scattering path. The second incorporates one path formed by using a Pt dopant atom to replace a neighboring hematite Fe (oxide-bridged Fe—Pt) (FIG. 8A). Compared to the pure Fe—O—Fe scattering path, inclusion of the N=1 Fe—O—Pt path better fits the experimental peak positions (r<0.07 vs r=0.39). Deviations in amplitude and position in the sample spectrum are due to surface site deviation from the bulk structures used for fitting; further planned spectroscopic and computational work is underway to more completely describe the structure of the SA Pt/Fe (III) active site.

### Additional Observations

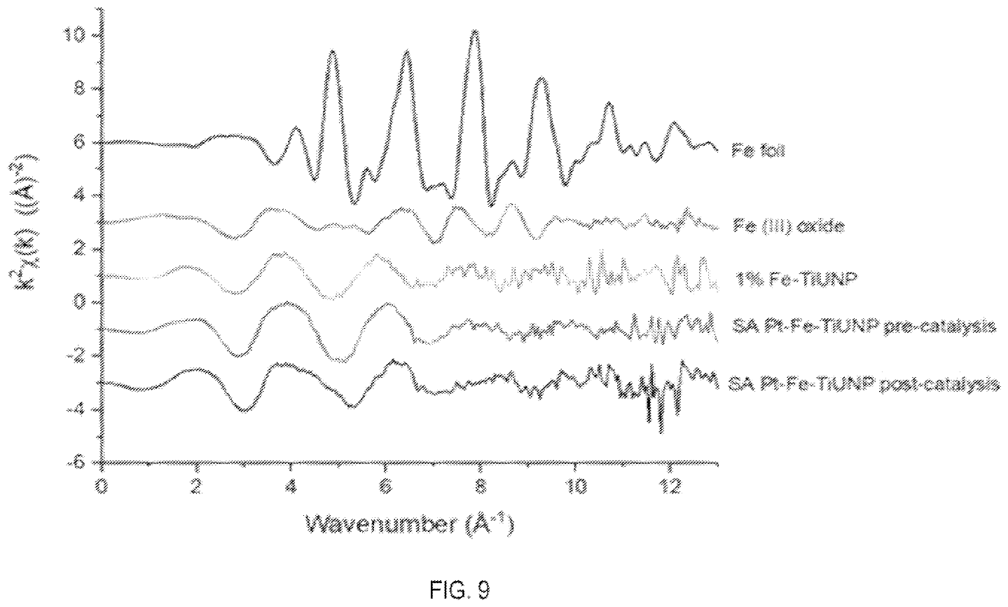

The observed consistent loss of signal in k-space (FIG. 9) past approximately 7 Å⁻¹ is consistent with UV-Vis size determination for TiUNP particles, lending further support to Fe surface sites on 1-2 nm TiUNP. As the scattering distance from a surface atom on an ultra-nano particle increases, it becomes more and more likely for the generated photoelectron to scatter into the air instead of the bulk of the nanoparticle. Loss of signal past about 0.7 nm is consistent with the calculated nanoparticle size d=1.5 nm.

### Implications of Fe/Pt Interactions

Both the interplay between Fe doping and Pt photodeposition and the observed Fe—O—Pt structure in SA Pt—Fe TiUNP suggest an interaction between Fe and Pt during the formation of Pt—O bonds on the TiUNP surface. It is hypothesized that during photodeposition, Fe³⁺ captures the photogenerated electron. The photogenerated hole likely localizes near the electrostatically adsorbed [PtCl₆]²⁻ ion. The hole activates a surface-bound —OH group, transferring a proton to the [PtCl₆]²⁻ ion and extruding HCl, a good leaving group. The resulting dangling Pt valence forms a Pt—O bond, capturing the Pt. Pt capture lowers the total surface energy resulting in a stable, atomically dispersed Pt—O surface site. The cycle repeats as further electron-hole pairs are generated, and additional Pt—O bonds form. At low Pt concentrations, Pt capture is more efficient than at higher concentrations (Table 3): 90% is captured when Pt:Fe·TiUNP is 0.04, while at the highest concentrations (0.8 Pt:Fe·TiUNP), capture drops to 38%, suggesting competition for favorable sites. One explanation is competition for physisorption of [Pt(Cl)₆]²⁻ due to the Cl⁻ coordination shell around TiUNPs containing high positive surface charge. Another possibility is that not all Fe dopant sites are equally active for photodeposition. More highly coordinated, non-corner/edge Fe atoms may experience greater barriers to physisorption of [Pt(Cl)₆]²⁻ compared to their undercoordinated counterparts. Resolution of these alternatives awaits further experiments and computational modeling, both in process.

TABLE 3
Comparison of conditions for Pt atom capture. Samples
containing more than 1.0 Fe:TiUNP no longer contain
SA Fe as the major Fe (III) surface site.

| Dep. time | | | Pt:TiUNP | % Pt | |
|---|---|---|---|---|---|
| (hr) | Fe:TiUNP | Pt:TiUNP | mole ratio | captured | SA Pt? |
| 4 | 0.44 | 0.0186 | 0.0168 | 90 | YES |
| 4 | 0.44 | 0.186 | 0.132 | 70 | YES |
| 4 | 0.44 | 0.372 | 0.143 | 38 | YES |
| 4 | 0.44 | 0.744 | 0.449 | 60 | NO |
| 4 | 1.04 | 0.372 | 0.170 | 45 | YES |
| 4 | 2.08 | 0.372 | 0.202 | 24 | YES |
| 4 | 7.29 | 0.372 | 0.220 | 59 | YES |
| 6 | 0.44 | 0.372 | 0.173 | 46 | NO |
| 6 | 1.04 | 0.372 | 0.193 | 52 | NO |

### Particle Size

Particle size is determined via an empirical connection between the inflection point of the UV-Vis absorption and size as determined by SEM. See, Ravel, B. & Newville, M., ATHENA, ARTEMIS, HEPHAESTUS: data analysis for X-ray absorption spectroscopy using IFEFFIT. J. Synchrotron Rad. 2005, 12, 537-541. Data for Fe·TiUNP and Pt13 Fe·TiUNP is shown in FIG. 11. Deposition of Pt slightly red-shifts the minimum and broadens the peak. Taken together, these reflect Pt capture by a portion of the particles. The mix of smaller and larger particles results in the larger size distribution reflected in the peak width.

### Photo-oxidation Kinetics

Impact of materials on photoefficiency is characterized via kinetics: The photocell is loaded with a solution containing the catalyst of interest and an initial concentration of target (formaldehyde in this case). The cell is irradiated with the lamp. Concentrations are chosen so that the target concentration is much greater than the catalyst particle concentration; the photon flux is smaller—the reaction is photon limited. Hence, the rate of target concentration reduction directly depends on the photoefficiency.

The impact of Pt is shown in FIG. 12 and FIG. 2. In the absence of Pt, formaldehyde is degraded at a rate of only 2.5% hr⁻¹. As controls, free Pt in solution produces only modest efficiency: only 5.5% hr⁻¹. In contrast, a mixture of 17% Pt—Fe·TiUNP and 83% Fe·TiUNP degrades 30% hr⁻¹. Kinetic data therefore reveal a cooperative effect between Pt and Fe which cannot be explained by simple addition of Pt precursor and Fe·TiUNP activities.

### Photodeposition Time Characterization

To examine the impact of photodeposition time on Pt speciation and catalytic activity, Pt—Fe·TiO₂ materials were generated by photodeposition of Pt onto Fe·TiUNP. Single atom capture occurs for up to 4 hr irradiation. Kinetic data shows that activity increases with increased Pt capture up to 4 hr. Beyond 4 hr., Pt clusters are formed and activity decreases. At the 6 hr mark the degradation rate drops to about a third that of a 4 hr deposition.

### XAS Data

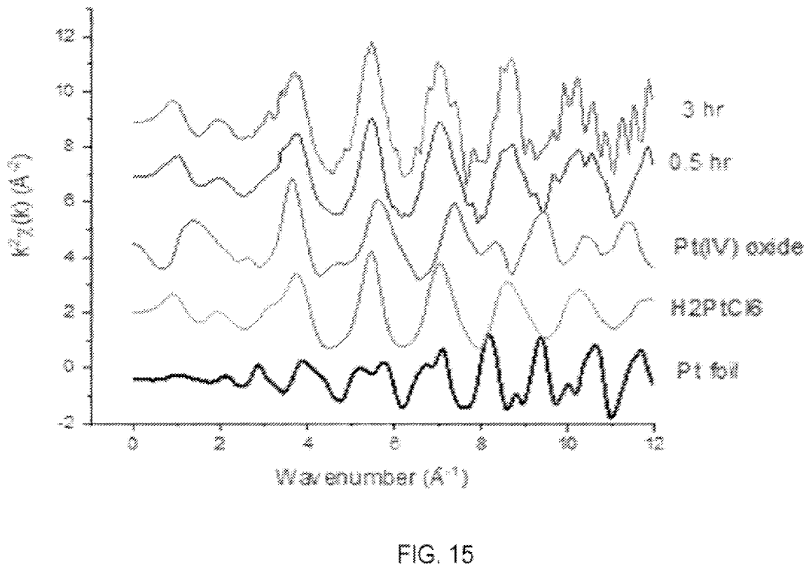

The Pt near edge structure (FIG. 15) shifts blue for positive oxidation states relative to metallic Pt. The maximum is about the same for Pt(II) in Pt(acac)₂ and Pt(IV) in H₂PtCl₆. Insensitivity to the II vs IV oxidation state is due to excitation from the L shell as opposed to the K shell used for lighter metals. Near the more electronegative oxygen atom, the edge shifts to the blue. These observations are important for interpreting the oxidation state in the Pt—Fe·TiUNP particles and changes with photo-oxidation discussed above.

Oxide versus chloride bonding to Pt is shown by the Im part of the scattering spectrum, discussed above. Here (FIG. 15) are shown the corresponding k-weight spectra. The greater noise in the deposition samples reflects the lower Pt content of the particles versus the foil and crystals. Scattering is a nonlinear process; the Im spectrum (discussed above) is more informative since it is a linear combination of the scattering paths.

### Calculation 1

Photoefficiency is defined as the number of oxidations per photon absorbed. The number of photons is approximated as follows. The Hg-Xe UV lamp outputs a light beam with a profile approximately equivalent to that in sunlight. The output that is absorbed by iron-doped titanium photocatalyst includes wavelengths from about 200 nm to 390 nm. As a conservative estimate of the number of photons, approximate the photon energy as that at the bulk anatase band gap, 385 nm.

The kinetic cell contains 25 mL a solution containing 50 mg/30 mL titania photocatalyst. Under 1.5 W irradiation (typical kinetic run conditions), ultranano titanium dioxide dispersion absorbs 0.183 W more than does a control cell with 18 megaohm water. Past work indicates very little (<0.1%) activity is due to visible light absorbance. The energy of a single photon is Ε=hc/λ, with λ=385*10⁻⁹ m: 3.52*10¹⁷ photons/s: 1.29*10²¹ photons/hr.

In a typical kinetic run Fe-TiUNP solution degrades 1.25 ppm of formaldehyde (2.5% of 50 ppm initial formaldehyde) under the aforementioned 0.183 W UV absorbance. A kinetic run degrades 1.04 micromolar formaldehyde. ((0.00125 g/L)/30 g/mol)*.03 L of solution *6.023*10²³ molecules/mol equals a total of 7.52*10¹⁸ molecules of formaldehyde degraded over the course of 60 minutes. Each formaldehyde requires the absorbance of 4 photons for its degradation: (4×7.52*10¹⁸) molecules/hr oxidations occur.

Putting these together, the photo efficiency=(7.52*10¹⁸ molecules/hr/1.29*10²¹ photons/hr)*4 photons a molecule=0.023*100%=2.3% for Fe·TiUNP. Pt—Fe-TiUNP is 15× as efficient as Fe·TiUNP, for a photo efficiency of ˜35%.

### Conclusions

This work demonstrates that thermodynamic principles, particularly the Gibbs-Wulff construction, act as powerful guides: both for generation of the ultra-nano particle substrate and for localization of dopants in specific faces. Past spectroscopic characterization has shown that single-atom Fe localizes in the [001] face of the TiUNP ultrananoparticles.²⁹ Due to the small size (<2 nm), there are few sites for the dopant; hence it forms a controlled or engineered defect. At the same time, the Fe (III)-Fe (II) couple captures and stabilizes the photogenerated electron. Stabilization quenches the competing hydrogen generation reaction making the electron available not only for capturing noble metal atoms in the absence of dissolved molecular oxygen but also for electron transfer to dissolved molecular oxygen when present. Since oxygen is the desired electron destination for environmentally friendly oxidation reactions, this is a double win.

Prior to photosynthesis, the Fe·TiUNPs are highly positively charged. The positive charge enhances capture of the PtCl₆²⁻ ion due to Coulombic attraction. The photogenerated electron localizes on the Fe (III) dopant, transferring to the PtCl₆²⁻ ion. Simultaneously, the photogenerated hole is localized on the surface-bound OH activating the OH bond and extruding HCl. The dangling bonds form a stable Pt—O-surface bond that both stabilizes single-atom Pt and makes it robust over multiple catalytic cycles. This sequence is supported by kinetic, CO-DRIFTS, and XAS data. This single atom Pt site exhibits significantly greater activity for formaldehyde oxidation than an equivalent mixture of Pt nanoclusters and Fe·TiUNP. Particularly notable is the superior quantum efficiency observed: around 35%, a 15-fold increase over F e TiUNP without SA Pt doping.

The catalyst synthesis described here uses the single atom Fe dopant as an engineered defect site for photodeposition and stabilization of single atom Pt, resulting in a hybrid, highly active photocatalyst. The larger importance of this work demonstrates that leveraging dopants as stable engineered defect sites enables efficient, facile, room-temperature synthesis of stable single atom catalysts. Deeper understanding of methodologies to easily generate single atom catalysts represents a major step towards their eventual practical deployment in a variety of important applications, such as efficient photocatalytic water remediation, catalytic converters, fuel cells, and selective chemical transformations. The usage of dopants as rationally engineered defect sites shows great promise as a future synthetic approach for the easy generation of stabilized SA catalysts in good yield.

1. A photocatalyst comprising a TiO₂ ultra-nanoparticle having a single Fe, Co, Mn, Cr, or W atom positioned as an engineered defect within the particle and a single metal catalyst atom bound proximal to the single Fe, Co, Mn, Cr, or W atom, wherein the single metal catalyst atom is in a positive oxidation state.

2. The photocatalyst of claim 1, wherein the single metal catalyst atom is selected from the group consisting of Pt, Pd, Ir, Ru, Rh, Os, Re, Au, Ni, Zn, and Cu.

3. The photocatalyst of claim 1, wherein the single metal catalyst atom is Pt.

4-13. (canceled)

14. The photocatalyst of claim 1, wherein the single Fe, Co, Mn, Cr, or W atom is a single Fe atom.

15-18. (canceled)

19. The photocatalyst of claim 1, wherein the ultra-nanoparticle has a diameter of between 0.8 nm and 2.5 nm.

20. The photocatalyst of claim 1, wherein the ultra-nanoparticle contains between 20 formula units of TiO₂ and 1000 formula units of TiO₂.

21. The photocatalyst of claim 1, wherein the ultra-nanoparticle contains between 50 formula units of TiO₂ and 200 formula units of TiO₂.

22. The photocatalyst of claim 1, wherein the engineered defect is located at a [001] facet of the TiO₂.

23. The photocatalyst of claim 1, wherein the TiO₂ is anatase.

24. The photocatalyst of claim 1, wherein the photocatalyst substantially has a particle shape of a truncated square bipyramid.

25. A composition comprising a plurality of the photocatalysts of claim 1.

26. The composition of claim 25, wherein the plurality of the photocatalysts is mixed with a plurality of otherwise identical particles that lack the single metal catalyst atom but are otherwise identical to the photocatalyst.

27. The composition of claim 26, wherein the photocatalyst is present in an amount by weight or by number of particles of between 2% and 100%.

28. The composition of claim 25, wherein the composition is a solution and/or a liquid suspension.

29. A film comprising the photocatalyst of claim 1.

30. A method of making a photocatalyst, the method comprising:
a) generating a plurality of ultra-nano TiO₂ particles, each having a single Fe, Co, Mn, Cr, or W atom positioned as an engineered defect within the particle; and
b) photodepositing a single metal catalyst atom proximal to the single Fe, Co, Mn, Cr, or W atom for at least a portion of the plurality of ultra-nano TiO₂ particles, thereby resulting in a portion of the plurality of ultra-nano TiO₂ particles having a single Fe, Co, Mn, Cr, or W atom positioned as an engineered defect within the particle and the single metal catalyst atom bound proximal to the single Fe, Co, Mn, Cr, or W atom.

31. The method of claim 30, wherein the photodepositing of step b) comprises photo irradiating the plurality of ultra-nano TiO₂ particles in the presence of a plurality of single metal catalyst atoms or ions, thereby capturing a portion of the single metal catalyst atoms or ions at the single Fe, Co, Mn, Cr, or W atom for at least a portion of the plurality of ultra-nano TiO₂ particles.

32. The method of claim 30, wherein the single metal catalyst atom is selected from the group consisting of Pt, Pd, Ir, Ru, Rh, Os, Re, Au, Ni, Zn, and Cu.

33. The method of claim 30, wherein the single metal catalyst atom is Pt.

34-43. (canceled)

44. The method of claim 30, wherein the single Fe, Co, Mn, Cr, or W atom is a single Fe atom.

45-48. (canceled)
